(19) United States
(12) Patent Application Publication
(10) Pub. No.: US 2025/0156043 A1
(43) Pub. Date: May 15, 2025

(54) METHOD FOR CONTROLLING AUTO-TUNING PROCESS WITH AID OF INTERACTIVE GRAPHICAL USER INTERFACE, AND ASSOCIATED APPARATUS

(71) Applicant: MEDIATEK INC., Hsinchu City (TW)

(72) Inventors: Kai-Ling Huang, Hsinchu City (TW); Ting-An Chien, Hsinchu City (TW); Yun-Chan Tsai, Hsinchu City (TW); Cheng-Sheng Chan, Hsinchu City (TW); Sheng-Je Hung, Hsinchu City (TW)

(73) Assignee: MEDIATEK INC., Hsinchu City (TW)

(21) Appl. No.: 18/943,973

(22) Filed: Nov. 12, 2024

Related U.S. Application Data
(60) Provisional application No. 63/598,132, filed on Nov. 12, 2023.

(51) Int. Cl. G06F 3/0484; G06F 3/04815; G06F 3/0482; G06N 3/126

(52) U.S. Cl. CPC G06F 3/0484; G06F 3/04815; G06F 3/0482; G06N 3/126

(57) ABSTRACT

A method for controlling an auto-tuning process with aid of an interactive graphical user interface (GUI) and associated apparatus (e.g., a computer) for running the interactive GUI are provided. The method may include: executing, by using a processing circuit within an electronic device, the auto-tuning process, for tuning a plurality of genetic-algorithm parameters (GA parameters) of a predetermined genetic algorithm; and during tuning the plurality of GA parameters, utilizing the interactive GUI to consolidate and aggregate real-time tuning data from the auto-tuning process in order to visualize the auto-tuning process with the interactive GUI, wherein visualizing the auto-tuning process with the interactive GUI may include generating at least one plot illustrating at least the real-time tuning data, for facilitating and accelerating interaction between a user and the auto-tuning process.

### CROSS REFERENCE TO RELATED APPLICATIONS

This application claims the benefit of U.S. Provisional Application No. 63/598,132, filed on Nov. 12, 2023. The content of the application is incorporated herein by reference.

### BACKGROUND

The present invention is related to parameter tuning control, and more particularly, to a method for controlling an auto-tuning process with aid of an interactive graphical user interface (GUI), and associated apparatus such as an electronic device (e.g., a computer) for running the interactive GUI.

According to the related art, genetic algorithms may be used for generating high-quality solutions in some situations. However, users often face challenges in observing the changes occurring in each generation during a parameter tuning process. In addition, it is often not possible for the users to interact with the parameter tuning process directly. Thus, a novel method and associated architecture are needed for solving the problems without introducing any side effect or in a way that is less likely to introduce a side effect.

### SUMMARY

It is an objective of the present invention to provide a method for controlling an auto-tuning process with aid of an interactive GUI, and associated apparatus such as an electronic device (e.g., a computer) for running the interactive GUI, in order to solve the above-mentioned problems.

At least one embodiment of the present invention provides a method for controlling an auto-tuning process with aid of an interactive GUI. For example, the method may comprise: executing, by using a processing circuit within an electronic device, the auto-tuning process, for tuning a plurality of genetic-algorithm parameters (GA parameters) of a predetermined genetic algorithm; and during tuning the plurality of GA parameters, utilizing the interactive GUI to consolidate and aggregate real-time tuning data from the auto-tuning process in order to visualize the auto-tuning process with the interactive GUI, wherein visualizing the auto-tuning process with the interactive GUI comprises generating at least one plot illustrating at least the real-time tuning data, for facilitating and accelerating interaction between a user and the auto-tuning process.

At least one embodiment of the present invention provides an apparatus for controlling an auto-tuning process with aid of an interactive GUI, where the apparatus may comprise a first processing circuit that is arranged to control operations of the apparatus, and the interactive GUI may be running on the first processing circuit. More particularly, a second processing circuit within an electronic device may be arranged to execute the auto-tuning process, for tuning a plurality of GA parameters of a predetermined genetic algorithm. In addition, during tuning the plurality of GA parameters, the interactive GUI running on the first processing circuit may be arranged to consolidate and aggregate real-time tuning data from the auto-tuning process in order to visualize the auto-tuning process with the interactive GUI, wherein visualizing the auto-tuning process with the interactive GUI comprises generating at least one plot illustrating at least the real-time tuning data, for facilitating and accelerating interaction between a user and the auto-tuning process. For example, the apparatus may comprise the electronic device, where the second processing circuit may be equal to the first processing circuit. For another example, the apparatus may comprise a first electronic device, where the electronic device mentioned above may represent a second electronic device that is coupled to the first electronic device via at least one network.

It is an advantage of the present invention that, through proper design, the method of the present invention, as well as the associated apparatus such as the electronic device (e.g., the computer) for running the interactive GUI, can control the aforementioned at least one plot such as one or more visualized plots to be configurable to suit specific requirements, and generate at least one interactive object for the user during visualizing the auto-tuning process with the interactive GUI to enable interactive communication with the auto-tuning process, and therefore can enhance the parameter tuning efficiency. In addition, the method of the present invention and the associated apparatus such as the electronic device (e.g., the computer) for running the interactive GUI can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first real-time-data consolidation and aggregation control scheme of a method for controlling an auto-tuning process with aid of an interactive GUI according to an embodiment of the present invention.

FIG. 2 illustrates a second real-time-data consolidation and aggregation control scheme of the method according to an embodiment of the present invention.

FIG. 3 illustrates a third real-time-data consolidation and aggregation control scheme of the method according to an embodiment of the present invention.

FIG. 4 illustrates a fourth real-time-data consolidation and aggregation control scheme of the method according to an embodiment of the present invention.

FIG. 5 illustrates a fifth real-time-data consolidation and aggregation control scheme of the method according to an embodiment of the present invention.

FIG. 6A illustrates a sixth real-time-data consolidation and aggregation control scheme of the method according to an embodiment of the present invention.

FIG. 6B illustrates some implementation details of the sixth real-time-data consolidation and aggregation control scheme shown in FIG. 6A.

FIG. 7 illustrates a first configuration involved with a configurable visualized plot control scheme of the method according to an embodiment of the present invention.

FIG. 8 illustrates a second configuration involved with the configurable visualized plot control scheme of the method according to an embodiment of the present invention.

FIG. 9 illustrates a third configuration involved with the configurable visualized plot control scheme of the method according to an embodiment of the present invention.

FIG. 10 illustrates a fourth configuration involved with the configurable visualized plot control scheme of the method according to an embodiment of the present invention.

FIG. 11 illustrates a fifth configuration involved with the configurable visualized plot control scheme of the method according to an embodiment of the present invention.

FIG. 12 illustrates an interactive communication control scheme of the method according to an embodiment of the present invention.

FIG. 13 illustrates an apparatus for controlling an auto-tuning process with aid of an interactive GUI according to an embodiment of the present invention, where the interactive GUI and the auto-tuning process may be running on the same electronic device.

FIG. 14 illustrates an apparatus for controlling an auto-tuning process with aid of an interactive GUI according to another embodiment of the present invention, where the interactive GUI and the auto-tuning process may be running on different electronic devices, respectively.

FIG. 15 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

Genetic algorithms may be used for generating high-quality solutions to optimization and search problems. For example, it may be workable on problem solving to start with a plurality of candidate solutions such as a population of candidate solutions and process with some predetermined operators in a genetic algorithm in order to find one or more better solutions, where the solutions may be expressed in binary as strings of 0s and 1s, but other representation methods may be possible. The practical use of the genetic algorithms seems to have limitations, especially when compared to alternative optimization algorithms. Although good results may have been reported for some classes of problems among the optimization and search problems, the generality and/or practicality of one or more hypotheses for explaining the efficiency seem to still remain doubted. In order to clarify this, more efforts on trying with the genetic algorithms may be needed. In addition, the genetic algorithms typically take a very long time on nontrivial problems, and the efficiency of parameter tuning is quite low. Embodiments of the present invention provide a method for controlling an auto-tuning process with aid of an interactive GUI, as well as associated apparatus (e.g., a computer) for running the interactive GUI, in order to complete the parameter tuning as soon as possible. For example, the apparatus may operate based on the method to control the auto-tuning process with aid of the interactive GUI, and associated operations may comprise:
(1) the apparatus may utilize a processing circuit within an electronic device to execute the auto-tuning process, for tuning a plurality of genetic-algorithm parameters (or “GA parameters”) of a predetermined genetic algorithm; and
(2) during tuning the plurality of GA parameters, the apparatus may utilize the interactive GUI to consolidate and aggregate real-time tuning data from the auto-tuning process in order to visualize the auto-tuning process with the interactive GUI;
where visualizing the auto-tuning process with the interactive GUI may comprise generating at least one plot (e.g., one or more plots) illustrating at least the real-time tuning data, for facilitating and accelerating interaction between a user and the auto-tuning process, but the present invention is not limited thereto. For example, visualizing the auto-tuning process with the interactive GUI may further comprise generating one or more interactive objects for the user to enable interactive communication with the auto-tuning process. More particularly, the apparatus may generate the one or more interactive objects within the interactive GUI to allow a user to set, change and/or update one or more configurations regarding visualizing the auto-tuning process with the interactive GUI, in order to enhance the overall performance of the auto-tuning process.

In addition, the real-time tuning data may comprise multiple calculation results collected from multiple calculation operations of the auto-tuning process during tuning the plurality of GA parameters. When utilizing the interactive GUI to consolidate and aggregate the real-time tuning data from the auto-tuning process in order to visualize the auto-tuning process with the interactive GUI, the apparatus may collect the multiple calculation results from the multiple calculation operations, for aggregating the real-time tuning data from the auto-tuning process, and illustrate the multiple calculation results with the aforementioned at least one plot, for consolidating the real-time tuning data from the auto-tuning process. For example, during collecting the multiple calculation results from the multiple calculation operations for aggregating the real-time tuning data from the auto-tuning process, the apparatus may collect the multiple calculation results from the multiple calculation operations while adjusting at least one GA parameter among the plurality of GA parameters, for aggregating the real-time tuning data from the auto-tuning process. In some examples, during illustrating the multiple calculation results with the aforementioned at least one plot for consolidating the real-time tuning data from the auto-tuning process, the apparatus may illustrate the multiple calculation results with the aforementioned at least one plot in a standardized data structure to ensure consistency, for consolidating the real-time tuning data from the auto-tuning process. No matter whether one or more problems among the optimization and search problems are trivial or not, the method and the associated apparatus of the present invention can visually present the auto-tuning process and provide an interactive platform to interact with the auto-tuning process, allowing the user to easily observe the changes occurring in each generation (e.g., any generation among multiple generations of tuning data regarding the predetermined genetic algorithm) during the auto-tuning process and to interact with the auto-tuning process directly, and therefore can significantly enhance the parameter tuning efficiency.

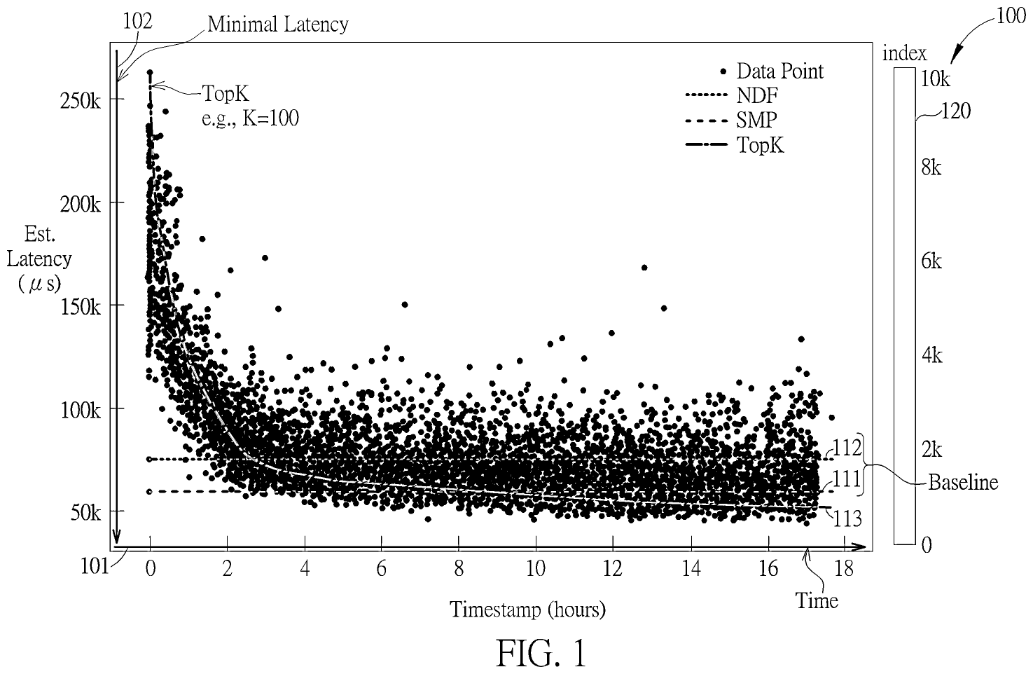

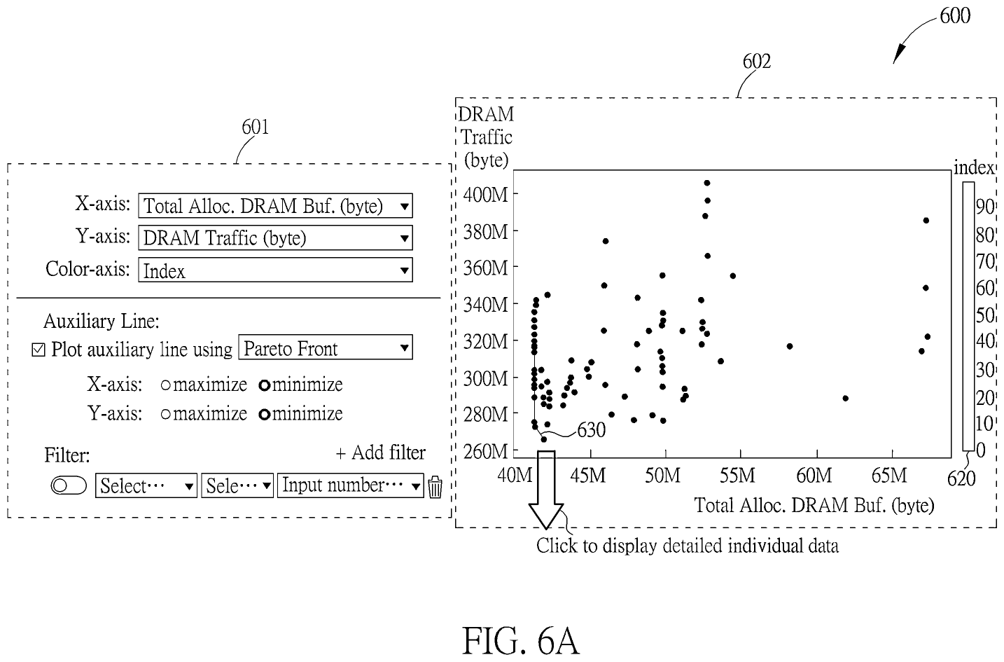

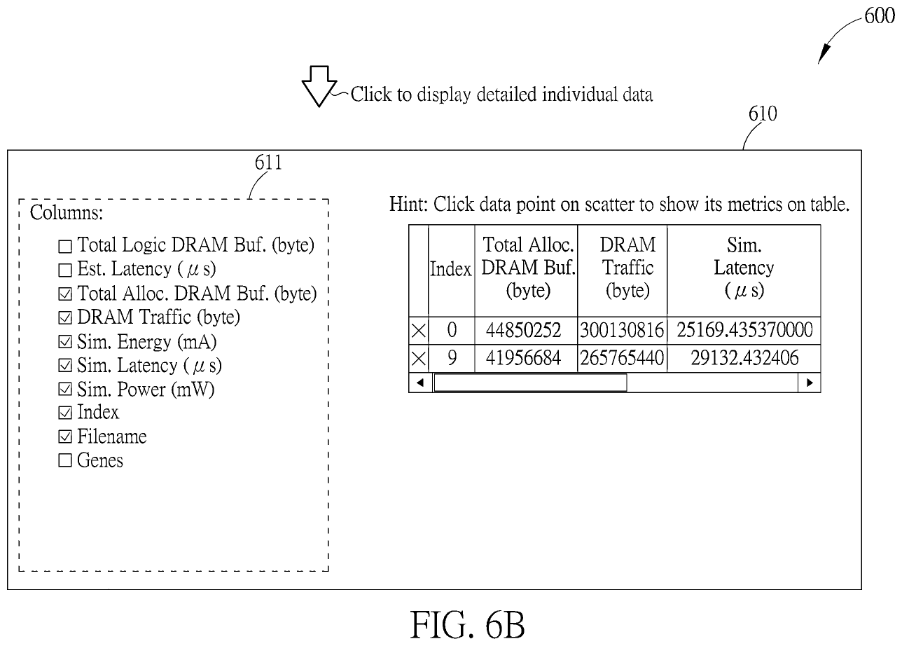

For better comprehension, the interactive GUI may be arranged to consolidate and aggregate the real-time tuning data from the auto-tuning process in order to visualize the auto-tuning process with the interactive GUI, for generating at least one visualization result (e.g., one or more visualization results) of visualizing the auto-tuning process with the interactive GUI, where the aforementioned at least one visualization result may comprise multiple visualization results of visualizing the auto-tuning process with the interactive GUI, such as that of the embodiments respectively shown in FIG. 1 to FIG. 5 as well as FIG. 6A and FIG. 6B.

FIG. 1 illustrates a first real-time-data consolidation and aggregation control scheme of the method according to an embodiment of the present invention. The horizontal axis (e.g., the X-axis) may represent the timestamp in units of hours, and the vertical axis (e.g., the Y-axis) may represent the estimated latency (or “the Est. Latency”) in units of microseconds (μs). The single-objective tuning visualization 100 such as the visualization 100 for single-objective tuning can be taken as an example of a first visualization result among the multiple visualization results of visualizing the auto-tuning process with the interactive GUI, where the single objective of the single-objective tuning may comprise an objective of achieving an extreme value with respect to a single axis, such as the minimal latency with respect to the vertical axis (e.g., the Y-axis), but the present invention is not limited thereto. According to some embodiments, the single objective of the single-objective tuning may vary.

The graphic items (or “the items”) for indicating data points of the real-time tuning data may be illustrated with a plurality of spots, but the present invention is not limited thereto. For example, a color varying bar 120 with the colors of various hues (e.g., at least one portion of the hues of the rainbow, such as a portion of hues or all hues among the hues of the rainbow) corresponding to the index (e.g., the index varying from 0 to 10k, in which “k” may stand for 10³) may be illustrated at one side of the single-objective tuning visualization 100, and the items for indicating the real-time tuning data may be illustrated as the plurality of spots with the associated colors. More particularly, the color varying bar 120 may be illustrated to have the colors changing from the lowermost part thereof to the uppermost part thereof, starting from red and changing to orange, yellow, green, etc., and the items for indicating the real-time tuning data may be illustrated with the plurality of spots having their colors varying from the left hand side to the right hand side, starting from red and changing to orange, yellow, green, etc. As shown in FIG. 1, the direction 101 may correspond to the time, increasing from the left hand side to the right hand side, and the direction 102 may correspond to the trend of the minimal latency, with the latency decreasing from the upper side to the lower side. In addition, the Top-K curve 113 may correspond to the “Top K” hyperparameter (or “the TopK”) such as a hyperparameter that ranks the K highest items based on a given time point. For example, if K is set to 100 (i.e., K=100), then the 100^{th} ranked item at each time point would be identified. Additionally, any baseline among multiple baselines (e.g., the baselines 111 and 112 respectively corresponding to the Symmetric Multi-Processing (SMP) and the Network Deep Fusion (NDF)) may be illustrated as a reference value used for convenient comparison of the tuned genes.

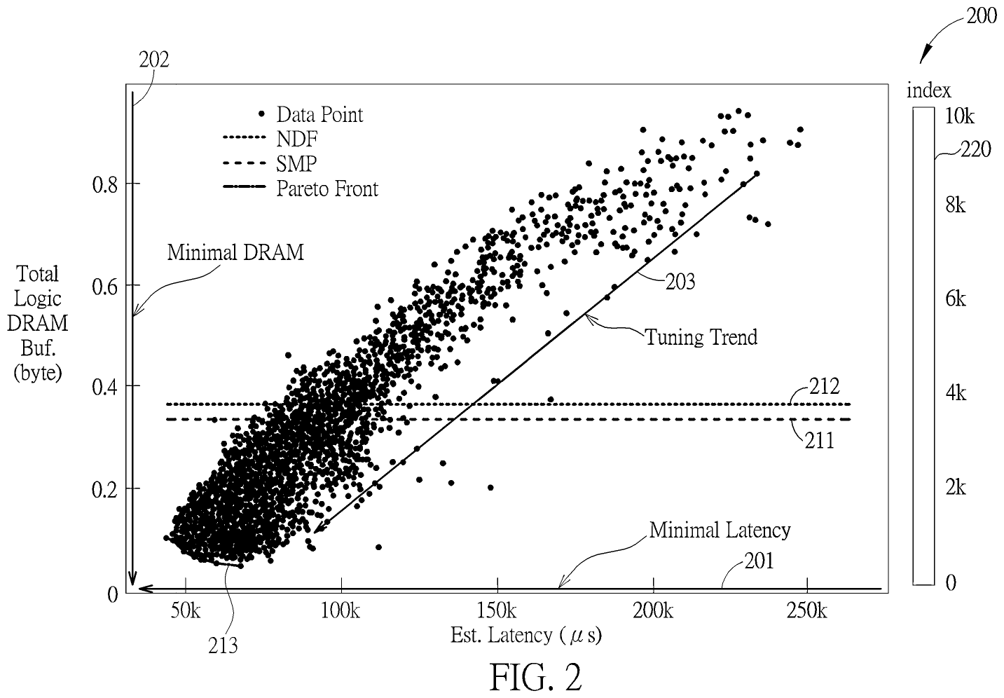

FIG. 2 illustrates a second real-time-data consolidation and aggregation control scheme of the method according to an embodiment of the present invention. The horizontal axis (e.g., the X-axis) may represent the estimated latency (or “the Est. Latency”) in units of us, and the vertical axis (e.g., the Y-axis) may represent the total logic dynamic random-access memory (DRAM) buffer (or “the Total Logic DRAM Buf.”) in units of bytes. The multi-objective tuning visualization 200 such as the visualization 200 for multi-objective tuning can be taken as an example of a second visualization result among the multiple visualization results of visualizing the auto-tuning process with the interactive GUI, where the multiple objectives of the multi-objective tuning may comprise a first objective of achieving a first extreme value with respect to a first axis, such as the minimal latency with respect to the horizontal axis (e.g., the X-axis), and comprise a second objective of achieving a second extreme value with respect to a second axis, such as the minimal DRAM with respect to the vertical axis (e.g., the Y-axis), but the present invention is not limited thereto. According to some embodiments, the multiple objectives of the multi-objective tuning may vary.

The items for indicating the real-time tuning data may be illustrated with a plurality of spots, but the present invention is not limited thereto. For example, a color varying bar 220 with the colors of various hues (e.g., at least one portion of the hues of the rainbow, such as a portion of hues or all hues among the hues of the rainbow) corresponding to the index (e.g., the index varying from 0 to 10k, in which “k” may stand for 10³) may be illustrated at one side of the multi-objective tuning visualization 200, and the items for indicating the real-time tuning data may be illustrated as the plurality of spots with the associated colors. More particularly, the color varying bar 220 may be illustrated to have the colors changing from the lowermost part thereof to the uppermost part thereof, starting from red and changing to orange, yellow, green, etc., and the items for indicating the real-time tuning data may be illustrated with the plurality of spots having their colors varying from the upper right corner to the lower left corner, starting from red and changing to orange, yellow, green, etc. As shown in FIG. 2, the direction 201 may correspond to the trend of the minimal latency with the latency decreasing from the right hand side to the left hand side, and the direction 202 may correspond to the trend of the minimal DRAM, with the total logic DRAM buffer size decreasing from the upper side to the lower side. In addition, the direction 203 may correspond to the tuning trend. The Pareto front 213 may be illustrated to present a set of optimal solutions that cannot be improved without degrading at least one other objective. They may show the possible trade-offs between different objectives. Additionally, any baseline among multiple baselines (e.g., the baselines 211 and 212 respectively corresponding to the SMP and the NDF) may be illustrated as a reference value used for convenient comparison of the tuned genes.

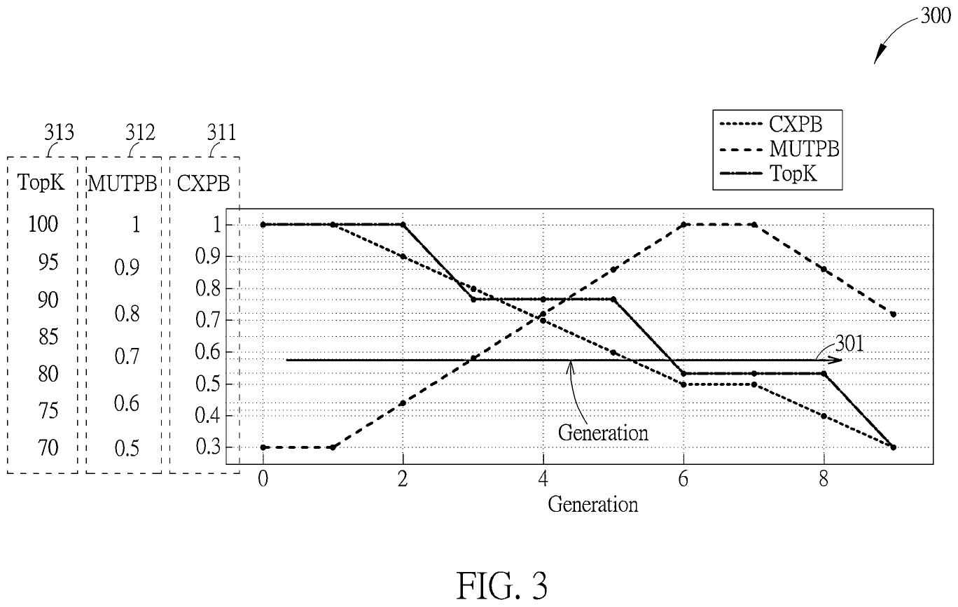

FIG. 3 illustrates a third real-time-data consolidation and aggregation control scheme of the method according to an embodiment of the present invention. The horizontal axis (e.g., the X-axis) may represent the generation, and the vertical axis (e.g., the Y-axis) may represent any hyperparameter among the multiple hyperparameters (e.g., the crossover probability for variation (CXPB), the mutation probability for variation (MUTPB) and the TopK). The hyperparameters configuring visualization 300 such as the visualization 300 for the configuring of multiple hyperparameters can be taken as an example of a third visualization result among the multiple visualization results of visualizing the auto-tuning process with the interactive GUI. For better comprehension, the configuring of the multiple hyperparameters may comprise the configuring history of the multiple hyperparameters, but the present invention is not limited thereto. According to some viewpoints, the configuring of the multiple hyperparameters may comprise the configuring history and/or the configuring log of the multiple hyperparameters, such as one or a combination of the configuring history of the multiple hyperparameters and the configuring log of the multiple hyperparameters. In addition, the multiple hyperparameters such as the CXPB, the MUTPB and the TopK as well as the scales thereof may be illustrated in multiple hyperparameter-scale regions 311, 312 and 313 within the hyperparameters configuring visualization 300, respectively.

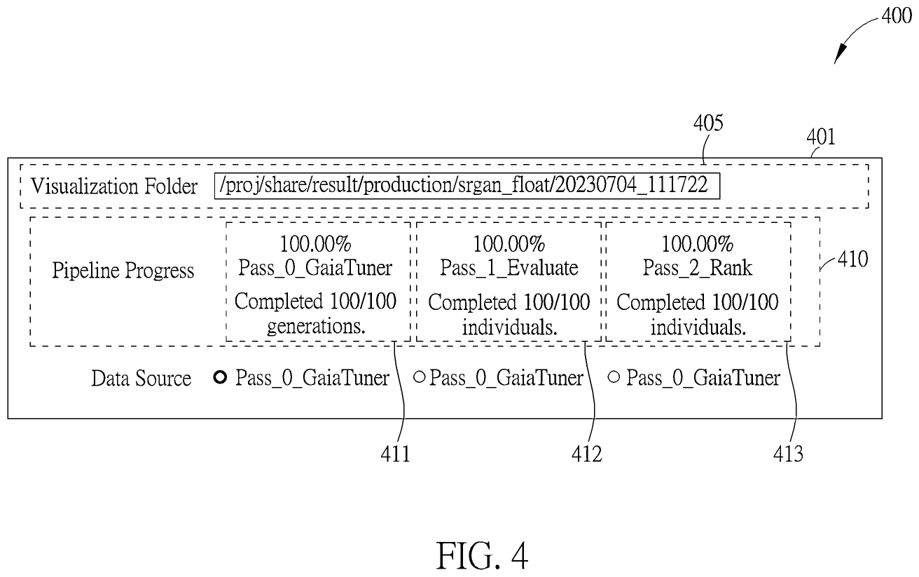

FIG. 4 illustrates a fourth real-time-data consolidation and aggregation control scheme of the method according to an embodiment of the present invention. The tuning-progress monitoring visualization 400 such as the visualization 400 for tuning-progress monitoring, the visualization 400 preferably implemented by using distinct progress indicators 411, 412 and 413 of multiple passes (e.g., Passes 0 to 2 for the Gaia-Tuner (or “the GaiaTuner”), the Evaluate and the Rank, respectively labeled “Pass_0_GaiaTuner”, “Pass_1_Evaluate” and “Pass_2_Rank” for brevity) of a pipeline (e.g., a processing pipeline) within a pipeline progress region 410 on a partial dashboard 401 within a dashboard, for monitoring the tuning progresses corresponding to the multiple passes, respectively, can be taken as an example of a fourth visualization result among the multiple visualization results of visualizing the auto-tuning process with the interactive GUI. As shown in FIG. 4, the pipeline progress region 410 may be named and labeled as “Pipeline Progress” for indicating that this region 410 is arranged to display the pipeline progress. In addition, any progress indicator among the progress indicators 411, 412 and 413 may comprise the name of the pass to which the aforementioned any progress indicator corresponds, as well as the progress of this pass, including an achievement percentage (e.g., 100%) of this pass and the associated counts such as the completed processing count and the total processing counts of this pass. For example, the completed processing count and the total processing counts in the progress indicator 411 may represent the completed generation count and the total generation count such as {100, 100} (labeled “Completed 100/100 generations” for brevity), and the completed processing count and the total processing counts in any of the progress indicators 412 and 413 may represent the completed individual count and the total individual count such as {100, 100} (labeled “Completed 100/100 individuals” for brevity). Additionally, the partial dashboard 401 may be illustrated to have a visualization folder region 405, which may be named and labeled “Visualization Folder” for indicating that this region 405 is arranged to display the path of the visualization folder for storing the associated file regarding visualizing the auto-tuning process, but the present invention is not limited thereto. According to some embodiments, the visualization folder region 405 may be arranged to input and/or change the e path of the visualization folder.

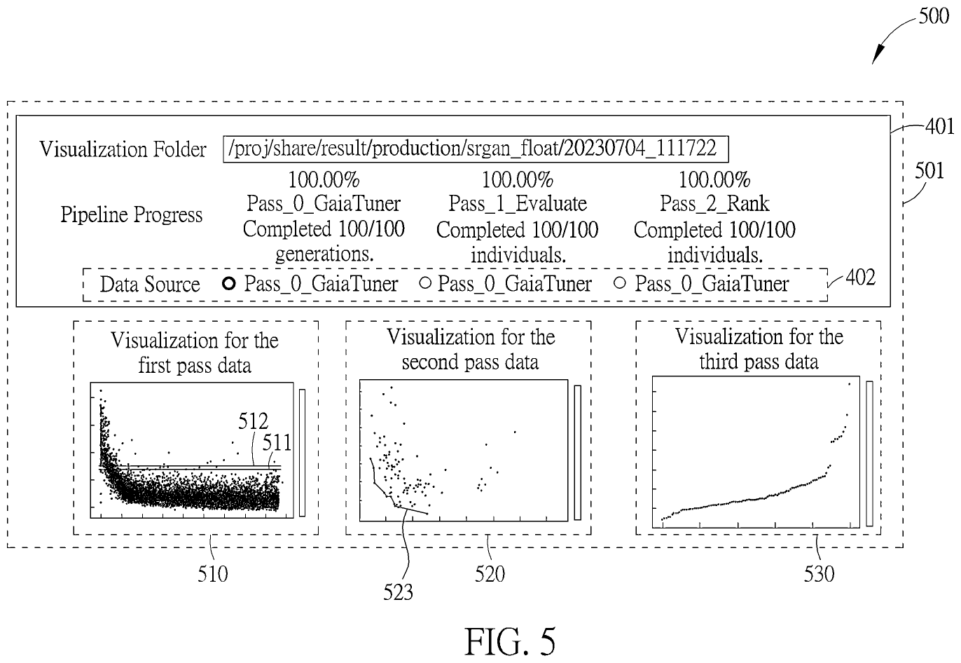

FIG. 5 illustrates a fifth real-time-data consolidation and aggregation control scheme of the method according to an embodiment of the present invention. The pass-in-pipeline monitoring visualization 500 such as the visualization 500 for pass-in-pipeline monitoring regarding the multiple passes in the pipeline (e.g., the processing pipeline), the visualization 500 preferably implemented by providing selectable objects (e.g., circle objects that are selectable) corresponding to the multiple passes for selecting any pass among all of the multiple passes (e.g., Passes 0 to 2 for the Gaia Tuner, the Evaluate and the Rank) in the pipeline from a data source region 420 on the partial dashboard 401, can be taken as an example of a fifth visualization result among the multiple visualization results of visualizing the auto-tuning process with the interactive GUI. The dashboard mentioned above may be implemented as the dashboard 501, and the dashboard 501 may comprise the partial dashboard 401 as well as the partial dashboards 510, 520 and 530 arranged to visualize the first pass data (e.g., the data of Pass 0), the second pass data (e.g., the data of Pass 1) and the third pass data (e.g., the data of Pass 1), and therefore the pass-in-pipeline monitoring visualization 500 may comprise the visualization for the first pass data, the second pass data and the third pass data in the partial dashboards 510, 520 and 530, respectively (labeled “Visualization for the first pass data”, “Visualization for the second pass data” and “Visualization for the third pass data” for better comprehension). In addition, the data source region 420 may be named and labeled “Data Source” for indicating that this region 420 is arranged to display and inputting the data source of the selected visualization (e.g., the visualization in any of the partial dashboards 510, 520 and 530) within the pass-in-pipeline monitoring visualization 500. For example, the data source region 420 may comprise multiple selectable objects respectively corresponding to the partial dashboards 510, 520 and 530, to allow the user to select at least one data source (e.g., one or more data sources) of the data to be visualized. When there is a need, the user may select all selectable objects among the multiple selectable objects, in order to see the respective visualization of the partial dashboards 510, 520 and 530 as displayed in the interactive GUI.

FIG. 6A illustrates a sixth real-time-data consolidation and aggregation control scheme of the method according to an embodiment of the present invention, and FIG. 6B illustrates some implementation details of the sixth real-time-data consolidation and aggregation control scheme shown in FIG. 6A. The individual-data pop-up visualization 600 such as the visualization 600 for illustrating any individual data among all individual data, including performance metrics and genes, in a pop-up manner, the visualization 600 preferably implemented by illustrating (e.g., displaying and/or listing) the aforementioned any individual data in detail in a table 610 when an item corresponding to the aforementioned any individual data in the individual-data pop-up visualization 600 is selected or clicked by the user, can be taken as an example of a sixth visualization result among the multiple visualization results of visualizing the auto-tuning process with the interactive GUI. The individual-data pop-up visualization 600 may comprise a dashboard 601 and a plot 602 as shown in FIG. 6A, and more particularly, further comprise the table 610 as shown in FIG. 6B. In response to one or more user inputs regarding the details of generating the plot 602, such as the inputs of a first axis option for defining the first axis (e.g., the X-axis) as a first type of data (e.g., the total allocated DRAM Buffer (or “the Total Alloc. DRAM Buf.”) in units of bytes), a second axis option for defining the second axis (e.g., the Y-axis) as a second type of data (e.g., the DRAM traffic in units of bytes), another axis option for defining another axis (e.g., the Color-axis) as another type of data (e.g., the index), and a reference-line option for displaying an auxiliary line corresponding to a data classification criterion (e.g., the Pareto front 603), the interactive GUI may be arranged to illustrate the plot 602 corresponding to the one or more user inputs. For example, the other axis such as the Color-axis may be illustrated as a color varying bar 620 with the colors of various hues (e.g., at least one portion of the hues of the rainbow, such as a portion of hues or all hues among the hues of the rainbow) corresponding to the index (e.g., the index varying from 0 to 100), and a plurality of items for indicating the real-time tuning data may be illustrated with a plurality of spots (e.g., spots having the colors of various hues) within the plot 602, but the present invention is not limited thereto. According to some embodiments, the dashboard 601, the plot 602 and/or the one or more user inputs may vary.

When there is a need, the user may use a pointing device such as a mouse to point to the item corresponding to the aforementioned any individual data (e.g., the data of interest), and the interactive GUI may be arranged to display and/or list the aforementioned any individual data in detail within the table 610 (labeled “Click to display detailed individual data” for brevity). As shown in FIG. 6B, the table 610 may comprise multiple detail-listing options 611 for selectively enabling or disabling the listing of multiple types of data within the table 610, respectively. For example, the multiple types of data may comprise the total logic DRAM buffer (or “the Total Logic DRAM Buf.”) in units of bytes, the estimated latency (or “the Est. Latency”) in units of us, the total allocated DRAM Buffer (or “the Total Alloc. DRAM Buf.”) in units of bytes, the DRAM traffic in units of bytes, the simulated energy (or “the Sim. Energy”) in units of milliamperes (mA), the simulated energy (or “the Sim. Latency”) in unit of us, the simulated power (or “the Sim. Power”) in unit of watts (W), the index, the filename and the genes, where one or more types of data among the multiple types of data listed above may have been selected by the user, but the present invention is not limited thereto. According to some embodiments, the table 610 and the format thereof, the arrangement direction such as the direction of arranging the table contents in columns, the multiple detail-listing options 611 for selectively enabling or disabling the listing of multiple types of data, the user inputs that are illustrated as the respective selection states of the multiple detail-listing options 611, the multiple types of data, and/or the details of the aforementioned any individual data that are listed as the table contents within the table 610 may vary.

Based on a configurable visualized plot control scheme of the method, the aforementioned at least one plot (e.g., one or more plots) may be configurable to suit at least one specific requirement (e.g., one or more specific requirements). More particularly, the aforementioned at least one plot may be generated according to at least one configuration among multiple predetermined configurations. For example, the multiple predetermined configurations may comprise a first configuration for providing multiple display options, a second configuration for providing multiple axis options, a third configuration for providing multiple reference-line options, a fourth configuration for providing multiple filter-out options, and a fifth configuration for providing multiple hyperparameter options.

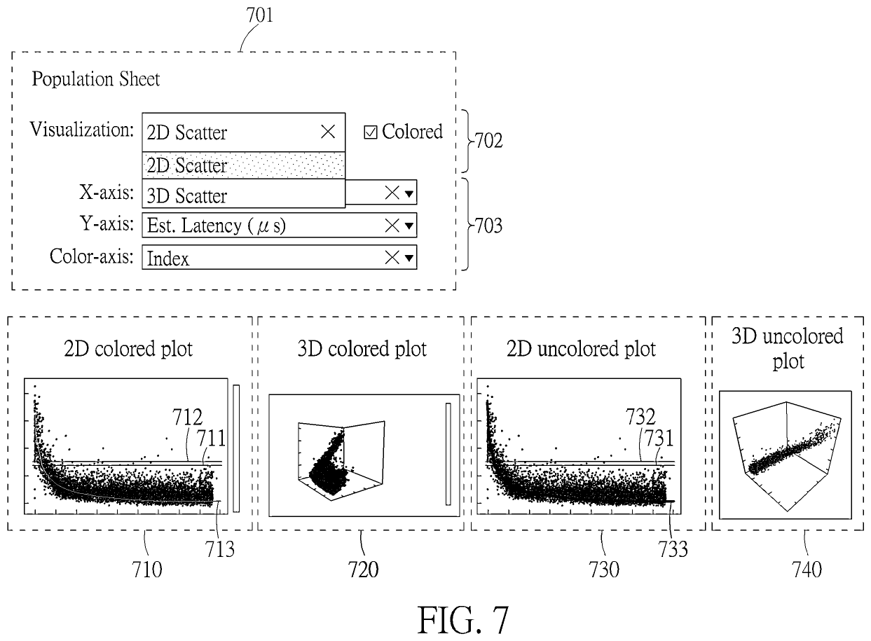

FIG. 7 illustrates the first configuration involved with the configurable visualized plot control scheme of the method according to an embodiment of the present invention. For example, a population sheet 701 of the interactive GUI may comprise a display option region 702 (labeled “Visualization” for brevity) and an axis option region 703. The aforementioned at least one plot may be generated according to the first configuration for providing the multiple display options such as the display options in the display option region 702, where the multiple display options may comprise a first display option for displaying the real-time tuning data using any plot among multiple multi-dimensional plot (e.g., a two-dimensional (2D) plot and a three-dimensional (3D) plot), and a second display option for displaying the real-time tuning data using any plot among a colored plot and an uncolored plot. As shown in FIG. 7, the first display option may be implemented with a pull-down menu having multiple entries (e.g., an entry “2D Scatter” for displaying with a 2D scatter plot, and another entry “3D Scatter” for displaying with a 3D scatter plot), and the second display option may be implemented with a checkbox (e.g., a checkbox named “Colored” for selectively displaying with a colored plot or a non-colored (or uncolored) plot according to whether this checkbox is checked by the user), but the present invention is not limited thereto. According to some embodiments, the first display option and the second display option may vary. In addition, in response to the user input regarding the first display option and the second display option, the interactive GUI may be arranged to display a currently selected plot corresponding the user input among multiple selectable plots (e.g., the 2D colored plot 710, the 3D colored plot 720, the 2D uncolored plot 730, and the 3D uncolored plot 740).

For better comprehension, when the entry “2D Scatter” for displaying with the 2D scatter plot is selected, the interactive GUI may be arranged to illustrate the first axis option for defining the first axis (e.g., the X-axis) as the first type of data, as well as the second axis option for defining the second axis (e.g., the Y-axis) as the second type of data (e.g., the estimated latency (or “the Est. Latency”) in units of us), in the axis option region 703; and when the entry “3D Scatter” for displaying with the 3D scatter plot is selected, the interactive GUI may be arranged to illustrate the first axis option for defining the first axis (e.g., the X-axis) as the first type of data, the second axis option for defining the second axis (e.g., the Y-axis) as the second type of data (e.g., the estimated latency (or “the Est. Latency”) in units of μs), as well as the other axis option for defining the other axis (e.g., the Color-axis) as the other type of data (e.g., the index), in the axis option region 703. This is for illustrative purposes only, and is not meant to be a limitation of the present invention. According to some embodiments, the associated axis options in the axis option region 703 may vary.

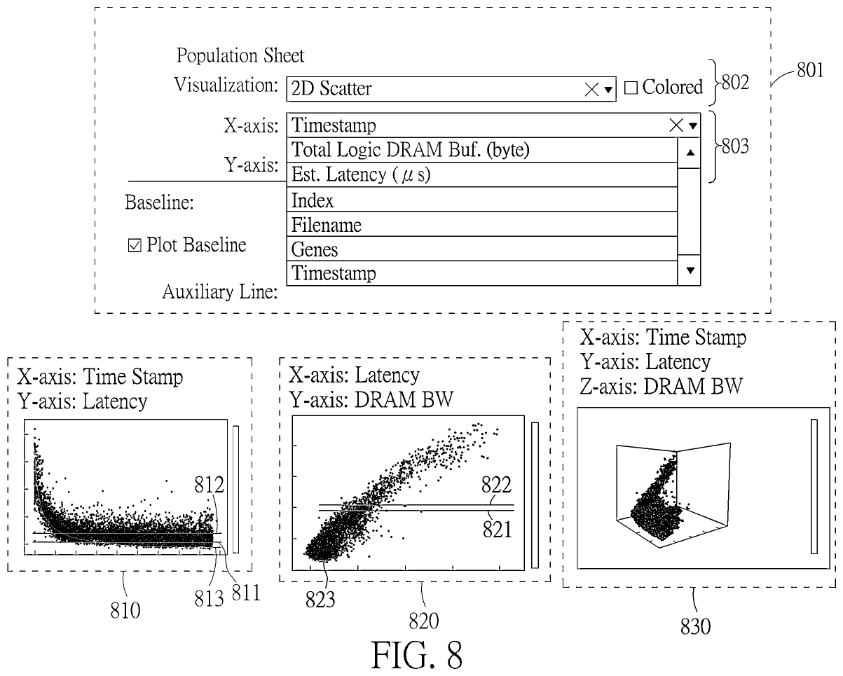

FIG. 8 illustrates the second configuration involved with the configurable visualized plot control scheme of the method according to an embodiment of the present invention. For example, a population sheet 801 of the interactive GUI may comprise a display option region 802 (labeled “Visualization” for brevity) and an axis option region 803. The aforementioned at least one plot may be generated according to the first configuration for providing the multiple display options such as the display options in the display option region 802, and according to the second configuration for providing the multiple axis options such as the axis options in the axis option region 803, where the multiple axis options may comprise at least two axis options (e.g., the first axis option for defining the first axis as the first type of data, and the second axis option for defining the second axis as the second type of data). The display option region 802 and the axis option region 803 of this embodiment may be the same as or similar to the display option region 702 and the axis option region 703 of the embodiment shown in FIG. 7, respectively.

For example, when the entry “2D Scatter” for displaying with the 2D scatter plot is selected, the multiple axis options may comprise the first axis option for defining the first axis as the first type of data, and the second axis option for defining the second axis as the second type of data, as well as the other axis option for defining the other axis as the other type of data; and when the entry “3D Scatter” for displaying with the 3D scatter plot is selected, the multiple axis options may comprise the first axis option for defining the first axis as the first type of data, the second axis option for defining the second axis as the second type of data, and a third axis option for defining a third axis as a third type of data, as well as the other axis option for defining the other axis as the other type of data. In addition, any axis option among the multiple axis options may be an axis option for defining the corresponding axis (e.g., the axis corresponding to the aforementioned any axis option) as a type of data among the multiple types of data, such as any data among the following data: the total logic DRAM buffer (or “the Total Logic DRAM Buf.”) in units of bytes, the estimated latency (or “the Est. Latency”) in units of us, the total allocated DRAM Buffer (or “the Total Alloc. DRAM Buf.”) in units of bytes, the DRAM traffic in units of bytes, the simulated energy (or “the Sim. Energy”) in units of mA, the simulated energy (or “the Sim. Latency”) in unit of us, the simulated power (or “the Sim. Power”) in unit of W, the index, the filename, the genes and the timestamp. This is for illustrative purposes only, and is not meant to be a limitation of the present invention. According to some embodiments, the aforementioned any axis option among the multiple axis options may vary.

For better comprehension, in response to the user input regarding the multiple axis options, the interactive GUI may be arranged to display a plot corresponding the user input among multiple selectable plots. For example, the multiple selectable plots may comprise the 2D colored plot 810 with the X-axis and the Y-axis being defined as the timestamp (or “the Time Stamp”) and the latency (e.g., the estimated latency), respectively, the 2D colored plot 820 with the X-axis and the Y-axis being defined as the latency (e.g., the estimated latency) and the DRAM bandwidth (BW) (e.g., the total logic DRAM buffer), respectively, and the 3D colored plot 830 with the X-axis, the Y-axis and the Z-axis being defined as the timestamp (or “the Time Stamp”), the latency (e.g., the estimated latency) and the DRAM BW (e.g., the total logic DRAM buffer), respectively, where the other axis such as the Color-axis is defined as the index in each plot among the 2D colored plot 810, the 2D colored plot 820 and the 3D colored plot 830, but the present invention is not limited thereto. According to some embodiments, the multiple selectable plots and/or the respective definitions of the associated axes may vary.

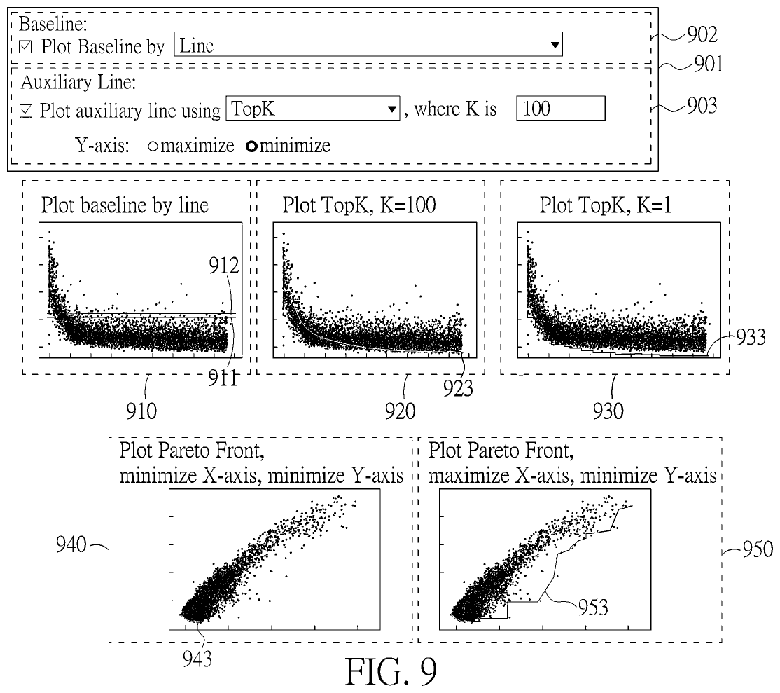

FIG. 9 illustrates the third configuration involved with the configurable visualized plot control scheme of the method according to an embodiment of the present invention. For example, a partial population sheet 901 may be a portion of the population sheet 801 shown in FIG. 8, and may comprise multiple reference-line option regions coming after the display option region 802 and the axis option region 803 shown in FIG. 8, such as the reference-line option region 902 regarding the baseline and the reference-line option region 903 regarding the auxiliary line (respectively labeled “Baseline:” and “Auxiliary Line:” for brevity). The aforementioned at least one plot may be generated according to the third configuration for providing the multiple reference-line options, where the multiple reference-line options may comprise a first reference-line option in the reference-line option region 902 for displaying at least one baseline with any drawing object among multiple predetermined drawing objects (e.g., the drawing object “Line”), and a second reference-line option in the reference-line option region 903 for displaying at least one auxiliary line corresponding to any data classification criterion among multiple predetermined data classification criteria (e.g., the data classification criteria of the TopK and the Pareto front). As shown in FIG. 9, the first reference-line option in the reference-line option region 902 may be implemented with a first checkbox (e.g., a checkbox named “Plot Baseline by” for selectively plotting the baseline according to whether this checkbox is checked by the user) as well as a first pull-down menu having multiple first entries (e.g., a first entry “Line” corresponding to the drawing object “Line” for displaying with the drawing object “Line” and one or more other first entries corresponding to one or more other drawing objects for displaying with the one or more other drawing objects), and the second reference-line option in the reference-line option region 903 may be implemented with a second checkbox (e.g., a checkbox named “Plot auxiliary line using” for selectively plotting the auxiliary line according to whether this checkbox is checked by the user) as well as a second pull-down menu having multiple second entries (e.g., a second entry “TopK” corresponding to the data classification criterion of the TopK for plotting the auxiliary line using the TopK, another second entry “Pareto front” corresponding to the data classification criterion of the Pareto front for plotting the auxiliary line using the Pareto front, and one or more other second entries corresponding to one or more other data classification criteria), but the present invention is not limited thereto. According to some embodiments, the first reference-line option and the second reference-line option may vary. Examples of the aforementioned at least one baseline may include, but are not limited to: the baselines 111 and 112 shown in FIG. 1, the baselines 211 and 212 shown in FIG. 2, the baselines 511 and 512 shown in FIG. 5, the baselines 711, 712, 731 and 732 shown in FIG. 7, the baselines 811, 812, 821 and 822 shown in FIG. 8 and the baselines 911 and 912 of the 2D uncolored plot 910 shown in FIG. 9. Examples of the aforementioned at least one auxiliary line may include, but are not limited to: the Top-K curve 113 shown in FIG. 1, the Pareto front 213 shown in FIG. 2, the Pareto front 523 shown in FIG. 5, the Pareto front 603 shown in FIG. 6A, the Top-K curves 713 and 733 shown in FIG. 7, the Top-K curve 813 and the Pareto front 823 shown in FIG. 8, as well as the Top-K curves 923 and 933 of the 2D uncolored plots 920 and 930 shown in FIG. 9 and the Pareto fronts 943 and 953 of the 2D uncolored plots 940 and 950 shown in FIG. 9.

For better comprehension, in response to the user input regarding the first reference-line option and the second reference-line option, the interactive GUI may be arranged to display a currently selected plot corresponding the user input among multiple selectable plots and plot the baseline(s) and/or the auxiliary line in the currently selected plot, where the multiple selectable plots may comprise the 2D uncolored plots 910, 920, 930, 940 and 950. For example, displaying the 2D uncolored plot 910 may comprise plotting the baselines 911 and 912 by line in the 2D uncolored plot 910, displaying the 2D uncolored plot 920 may comprise plotting the Top-K curve 923 with K=100 in the 2D uncolored plot 920, displaying the 2D uncolored plot 930 may comprise plotting the Top-K curve 933 with K=1 in the 2D uncolored plot 930, displaying the 2D uncolored plot 940 may comprise plotting the Pareto front 943 in the 2D uncolored plot 940, and displaying the 2D uncolored plot 950 may comprise plotting the Pareto front 953 in the 2D uncolored plot 950. The Pareto front (e.g., the Pareto front 943 or the Pareto front 953) in the multi-objective optimization may present a set of optimal solutions that cannot be improved without degrading at least one other objective, and the set of solutions may show the possible trade-offs between different objectives. For example, in the 2D uncolored plot 940 illustrated with respect to the horizontal axis such as the X-axis and the vertical axis such as the Y-axis, the Pareto front 943 may present the set of optimal solutions in which any optimal solution may have the minimum/minimized X-coordinate and the minimum/minimized Y-coordinate in comparison with at least one portion of other optimal solutions (e.g., a portion of other optimal solutions or all other optimal solutions) among the set of optimal solutions (labeled “minimize X-axis, minimize Y-axis” for brevity). In another example, in the 2D uncolored plot 950 illustrated with respect to the horizontal axis such as the X-axis and the vertical axis such as the Y-axis, the Pareto front 953 may present the set of optimal solutions in which any optimal solution may have the maximum/maximized X-coordinate and minimum/minimized Y-coordinate in comparison with at least one portion of other optimal solutions (e.g., a portion of other optimal solutions or all other optimal solutions) among the set of optimal solutions (labeled “maximize X-axis, minimize Y-axis” for brevity).

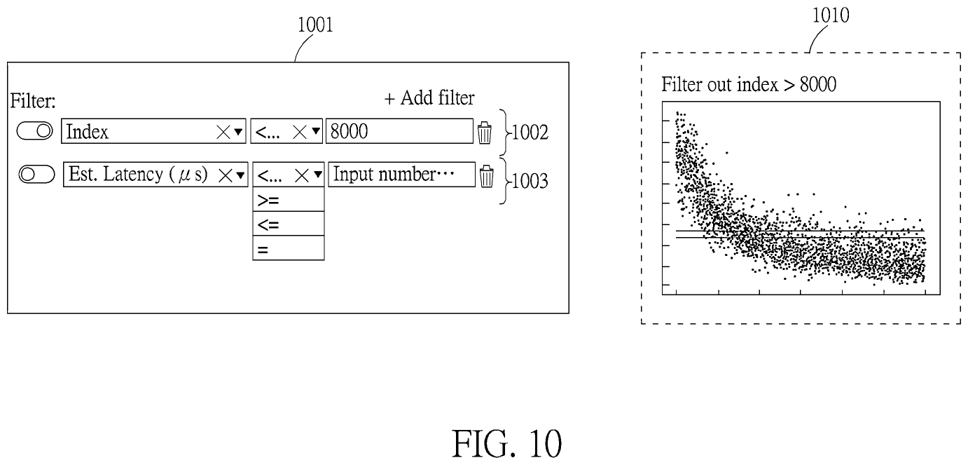

FIG. 10 illustrates the fourth configuration involved with the configurable visualized plot control scheme of the method according to an embodiment of the present invention. For example, a partial population sheet 1001 may be another portion of the population sheet 801 shown in FIG. 8, such as the next portion coming after the partial population sheet 901 shown in FIG. 9, and may comprise multiple filter-out option regions coming after the multiple reference-line option regions (e.g., the reference-line option regions 902 and 903) of the partial population sheet 901, such as the filter-out option region 1002 regarding a first filter and the filter-out option region 1003 regarding a second filter (collectively labeled “Filter:” for brevity). The aforementioned at least one plot may be generated according to the fourth configuration for providing the multiple filter-out options, where the multiple filter-out options may comprise a first filter-out option in the filter-out option region 1002 for filtering out a first portion of data that is not of interest according to a first user-setting range (e.g., the user-setting range defined by multiple first fields in the filter-out option region 1002), and a second filter-out option in the filter-out option region 1003 for filtering out a second portion of data that is not of interest according to a second user-setting range (e.g., the user-setting range defined by multiple second fields in the filter-out option region 1003). As shown in FIG. 10, the first filter-out option in the reference-line option region 1002 may be implemented with a first switch object for selectively enabling filtering out the first portion of data, a first pull-down menu having multiple entries (e.g., an entry “Index” corresponding to the data type “Index” for filtering out the first portion of data in the data type “Index”), as well as another first pull-down menu having multiple entries “>=”, “<=” and “=” and an input field for defining the first user-setting range, and the second filter-out option in the reference-line option region 1003 may be implemented with a second switch object for selectively enabling filtering out the second portion of data, a second pull-down menu having multiple entries (e.g., an entry “Est. Latency (μs)” corresponding to the data type “Est. Latency (μs)” for filtering out the second portion of data in the data type “Est. Latency (μs)”), as well as another second pull-down menu having multiple entries “>=”, “<=” and “=” and an input field for defining the second user-setting range, but the present invention is not limited thereto. According to some embodiments, the first filter-out option and the second filter-out option may vary.

For better comprehension, in response to the user input regarding the first filter-out option and the second filter-out option, the interactive GUI may be arranged to display the data of interest corresponding the user input in the 2D colored plot 1010, where the interactive GUI may filter out the data having the index greater than 8000, and illustrate the data of interest, such as the data having the index less than or equal to 8000, but the present invention is not limited thereto.

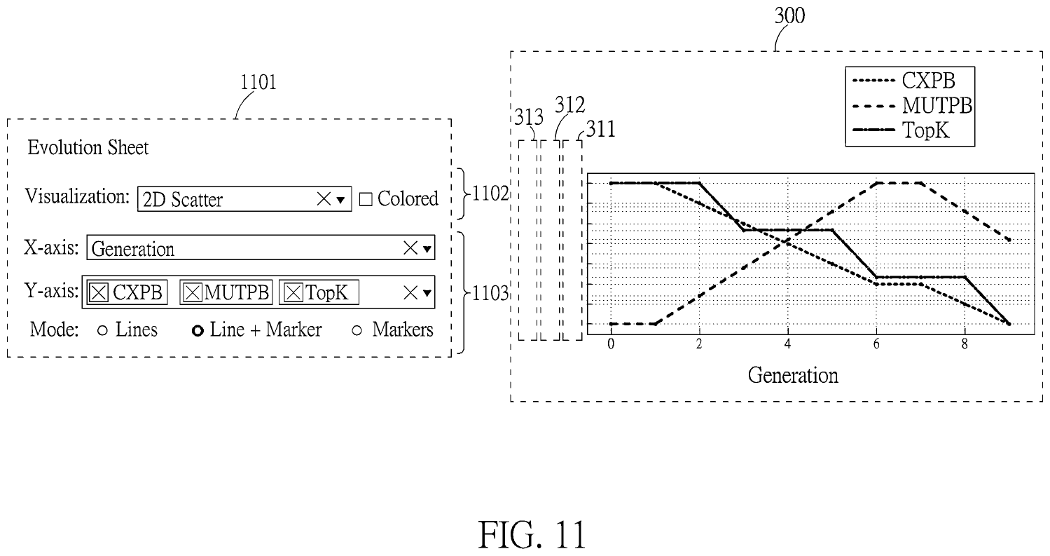

FIG. 11 illustrates the fifth configuration involved with the configurable visualized plot control scheme of the method according to an embodiment of the present invention. For example, another sheet 1101 (e.g., “the Evolution Sheet”) of the interactive GUI may comprise a display option region 1102 (labeled “Visualization” for brevity) that is similar to or the same as the display option region 802 within the population sheet 801 shown in FIG. 8, as well as a hyperparameter option region 1103 with at least the uppermost part thereof being similar to that of the axis option region 803 within the population sheet 801. As at least one portion (e.g., a portion or all) of the hyperparameter option region 1103 may be similar to that of the axis option region 803, the hyperparameter option region 1103 may also be regarded as an axis option region. The aforementioned at least one plot may be generated according to the fifth configuration for providing the multiple hyperparameter options such as the hyperparameter options in the hyperparameter option region 1103, where the multiple hyperparameter options may comprise a first hyperparameter option for displaying a first hyperparameter such as the CXPB, a second hyperparameter option for displaying a second hyperparameter such as the MUTPB, and a third hyperparameter option for displaying a third hyperparameter such as the TopK.

The interactive GUI may be arranged to display the hyperparameters according to a plurality of configurable options (e.g., the multiple display options, the multiple axis options and/or the multiple hyperparameter options). Taking the hyperparameters configuring visualization 300 mentioned above as an example, the aforementioned at least one plot may be generated according to the first configuration for providing the multiple display options such as the display options in the display option region 1102 (e.g., the display options in any of the display option regions 702 and 802), and the second configuration for providing the multiple axis options such as the axis options in the hyperparameter option region 1103, where the second configuration of this embodiment may be arranged to provide the multiple hyperparameter options such as the first hyperparameter option, the second hyperparameter option and the third hyperparameter option. As shown in FIG. 11, the multiple axis options may comprise the first axis option for defining the first axis (e.g., the X-axis) as the first type of data (e.g., the Generation corresponding to the entry “Generation” in the pull-down menu on the uppermost part of the hyperparameter option region 1103), and the second axis option for defining the second axis (e.g., the Y-axis) as the second type of data (e.g., the CXPB, the MUTPB and the TopK respectively corresponding to the selectable entries “CXPB”, “MUTPB” and “TopK” in the pull-down menu on the central part of the hyperparameter option region 1103), but the present invention is not limited thereto. According to some embodiments, the multiple display options, the multiple axis options and/or the multiple hyperparameter options may vary. In addition, the multiple display options may further comprise a mode option for selecting a mode among multiple predetermined modes “Line”, “Line plus Makers” (or “Line+Makers”) and “Markers” for controlling the hyperparameters to be illustrated with the drawing object(s) “Line”, the drawing objects “Line” and “Makers” and the drawing objects “Markers” in the hyperparameters configuring visualization 300, respectively. For brevity, similar descriptions for this embodiment are not repeated in detail here.

According to some embodiments, the interactive GUI may comprise at least one dashboard such as the dashboards 501 and 601 respectively shown in FIG. 5 and FIG. 6A as well as at least one other dashboard implemented as at least one predetermined sheet, where the aforementioned at least one predetermined sheet may comprise one or a combination of the population sheets 701 and 801 respectively shown in FIG. 7 and FIG. 8, the partial population sheets 901 and 1001 respectively shown in FIG. 9 and FIG. 10 as well as the sheet 1101 shown in FIG. 11. For brevity, similar descriptions for these embodiments are not repeated in detail here.

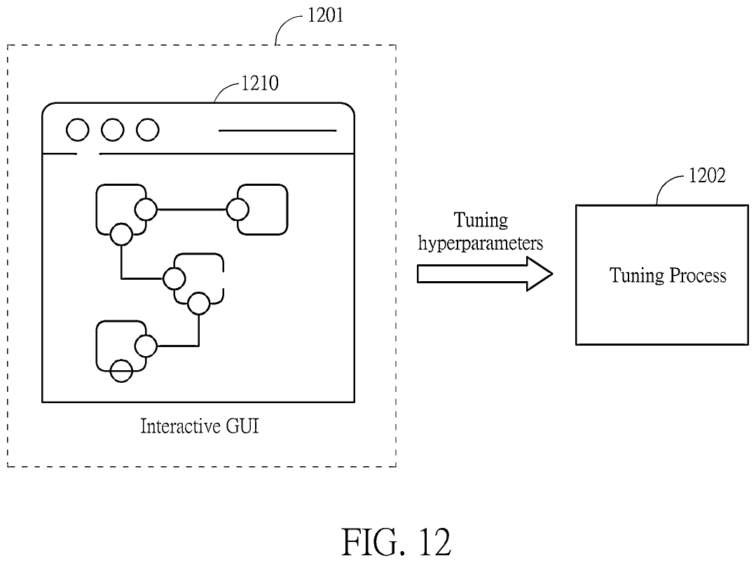

FIG. 12 illustrates an interactive communication control scheme of the method according to an embodiment of the present invention, where the interactive GUI mentioned above may be illustrated as the interactive GUI 1201, but the present invention is not limited thereto. For example, visualizing the auto-tuning process with the aforementioned interactive GUI such as the interactive GUI 1201 may further comprise generating at least one interactive object (e.g., the one or more interactive objects), which may be collectively referred to as the interactive object 1210, for the user to enable interactive communication with the auto-tuning process, where the interactive object 1210 may comprise at least one portion (e.g., a portion or all) of the aforementioned at least one dashboard, such as one or a combination of the following dashboards and/or sheets: the dashboards 501 and 601 respectively shown in FIG. 5 and FIG. 6A, the population sheets 701 and 801 respectively shown in FIG. 7 and FIG. 8, the partial population sheets 901 and 1001 respectively shown in FIG. 9 and FIG. 10 as well as the sheet 1101 shown in FIG. 11. More particularly, the aforementioned at least one interactive object may be arranged to input a user setting regarding at least one hyperparameter among the multiple hyperparameters related to the predetermined genetic algorithm into the auto-tuning process, in order to make the multiple hyperparameters become adjustable at any time. According to some viewpoints in the machine learning field, the hyperparameters may be regarded as static parameters specifying predetermined details such as the learning rate, the choice of optimizer(s), etc., for controlling the learning process (e.g., the auto-tuning process) of a predetermined model, while the other parameters (e.g., the weightings of the nodes in the predetermined model) may be obtained from training. For better comprehension, assume that one or more functions of the apparatus of the present invention may be temporarily disabled to allow the apparatus to operate according to a non-GUI control scheme and therefore skip using the inactive GUI, but the present invention is not limited thereto. Based on the non-GUI control scheme, the multiple hyperparameters may seem to be non-adjustable. As the interactive GUI 1201 implemented according to the method makes it possible to interact with the auto-tuning process (e.g., the tuning process 1202) by the user, the multiple hyperparameters that originally seem to be non-adjustable may become adjustable at any time. When there is a need, the user may manually tune the aforementioned at least one hyperparameter via the aforementioned at least one interactive object of the interactive GUI 1201 (labeled “Tuning hyperparameters” for brevity). As a result, tuning the plurality of GA parameters with the auto-tuning process (e.g., the tuning process 1202) can be completed as soon as possible. For brevity, similar descriptions for this embodiment are not repeated in detail here.

According to some embodiments, the apparatus for controlling the auto-tuning process with aid of the interactive GUI may comprise a first processing circuit (e.g., a processor) that is arranged to control operations of the apparatus, and the interactive GUI may be running on the first processing circuit. More particularly, a second processing circuit within an electronic device, such as the processing circuit within the electronic device mentioned above, may be arranged to execute the auto-tuning process, for tuning the plurality of GA parameters of the predetermined genetic algorithm. In addition, during tuning the plurality of GA parameters, the interactive GUI running on the first processing circuit may be arranged to consolidate and aggregate the real-time tuning data from the auto-tuning process in order to visualize the auto-tuning process with the interactive GUI, where visualizing the auto-tuning process with the interactive GUI may comprise generating the aforementioned at least one plot illustrating at least the real-time tuning data, for facilitating and accelerating the interaction between the user and the auto-tuning process. For example, in a first case, the apparatus may comprise the electronic device, where the second processing circuit may be equal to the first processing circuit, but the present invention is not limited thereto. In a second case, the apparatus may comprise a first electronic device, where the electronic device mentioned above may represent a second electronic device that is coupled to the first electronic device via at least one network.

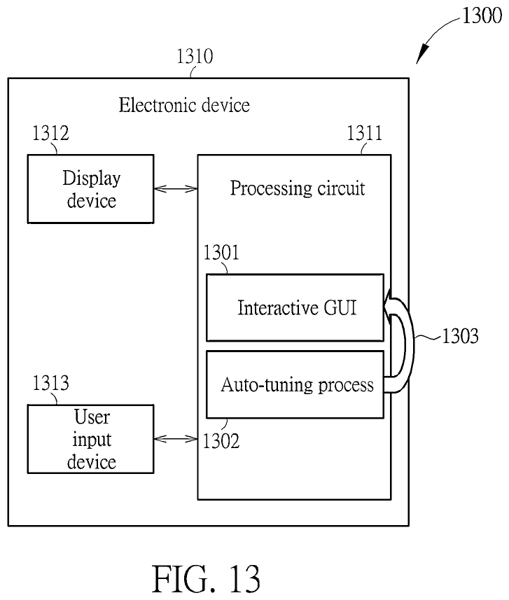

FIG. 13 illustrates an apparatus 1300 for controlling an auto-tuning process 1302 with aid of an interactive GUI 1301 according to an embodiment of the present invention, where the interactive GUI 1301 and the auto-tuning process 1302 may be running on the same electronic device 1310. The electronic device 1310 may comprise a processing circuit 1311, a display device 1312 and a user input device 1313. For the first case, the apparatus 1300 may comprise the electronic device 1310, and the first processing circuit and the second processing circuit may be implemented as the same processing circuit 1311 for executing both of the interactive GUI 1301 and the auto-tuning process 1302. In the architecture shown in FIG. 13, the processing circuit 1311 can be implemented by way of at least one processor, at least one random access memory (RAM), at least one bus, etc., the display device 1312 can be implemented by way of a display panel such as a liquid crystal display (LCD) panel, a projector, etc., and the user input device 1313 can be implemented by way of a keyboard, a mouse, etc., but the present invention is not limited thereto. Examples of the electronic device 1310 may include, but are not limited to: a server, an enterprise-grade computer, etc. For brevity, similar descriptions for this embodiment are not repeated in detail here.

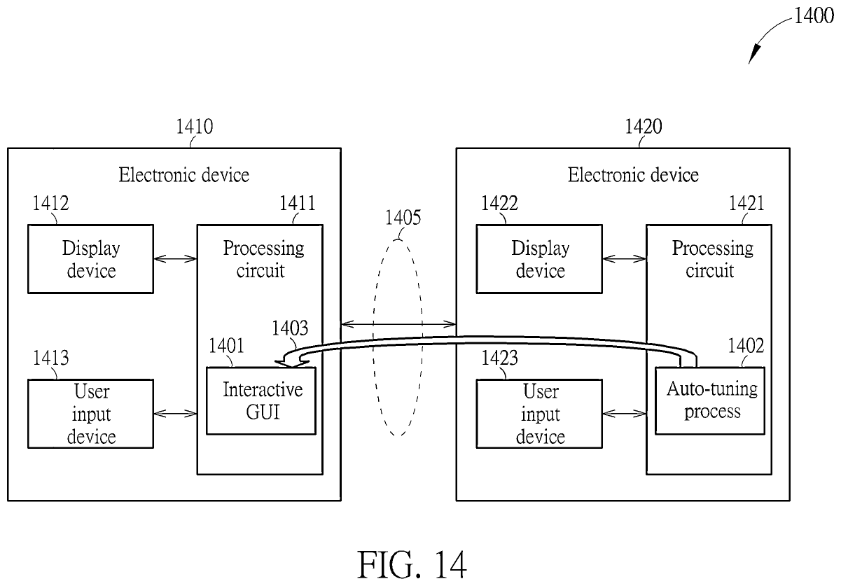

FIG. 14 illustrates an apparatus 1400 for controlling an auto-tuning process 1402 with aid of an interactive GUI 1401 according to another embodiment of the present invention, where the interactive GUI 1401 and the auto-tuning process 1402 may be running on different electronic devices 1410 and 1420, respectively. The electronic device 1410 may comprise a processing circuit 1411, a display device 1412 and a user input device 1413, and the electronic device 1420 may comprise a processing circuit 1421, a display device 1422 and a user input device 1423. For the second case, the apparatus 1400 may comprise the electronic device 1410, and more particularly, may further comprise the electronic device 1420 that is coupled to the electronic device 1410 via the aforementioned at least one network (e.g., one or more networks), which may be collectively referred to as the network 1405. In addition, the first processing circuit and the second processing circuit may be implemented as the processing circuits 1411 and 1421, respectively, for executing the interactive GUI 1401 and the auto-tuning process 1402, respectively. In the architecture shown in FIG. 14, any processing circuit among the processing circuits 1411 and 1421 can be implemented by way of at least one processor, at least one RAM, at least one bus, etc., any display device among the display devices 1412 and 1422 can be implemented by way of a display panel such as an LCD panel, a projector, etc., and any user input device among the user input devices 1413 and 1423 can be implemented by way of a keyboard, a mouse, etc., but the present invention is not limited thereto. Examples of the electronic device 1410 may include, but are not limited to: a multifunctional mobile phone, a laptop computer, a desktop computer and an all-in-one computer. Examples of the electronic device 1420 may include, but are not limited to: a server, an enterprise-grade computer, etc. For brevity, similar descriptions for this embodiment are not repeated in detail here.

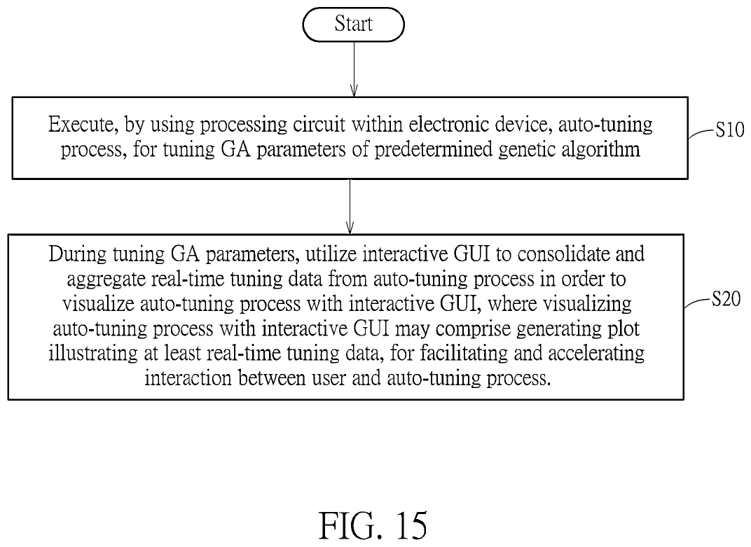

FIG. 15 illustrates a working flow of the method according to an embodiment of the present invention. The apparatus for controlling the auto-tuning process with aid of the interactive GUI, such as any apparatus among the apparatus 1300 shown in FIG. 13 and the apparatus 1300 shown in FIG. 14, may operate based on the method to perform the operations of Steps S10 and S20 of the working flow shown in FIG. 15.

In Step S10, the apparatus (e.g., the apparatus 1300 or the apparatus 1400) may execute, by using the processing circuit within the electronic device mentioned above, the auto-tuning process, for tuning the plurality of GA parameters of the predetermined genetic algorithm. For the first case, the apparatus 1300 may execute, by using the processing circuit 1311 within the electronic device 1310, the auto-tuning process 1302, for tuning the plurality of GA parameters of the predetermined genetic algorithm. For the second case, the apparatus 1400 may execute, by using the processing circuit 1421 within the electronic device 1420, the auto-tuning process 1402, for tuning the plurality of GA parameters of the predetermined genetic algorithm.

In Step S20, during tuning the plurality of GA parameters, the apparatus (e.g., the apparatus 1300 or the apparatus 1400) may utilize the interactive GUI to consolidate and aggregate the real-time tuning data from the auto-tuning process in order to visualize the auto-tuning process with the interactive GUI, where visualizing the auto-tuning process with the interactive GUI may comprise generating the aforementioned at least one plot illustrating at least the real-time tuning data, for facilitating and accelerating the interaction between the user and the auto-tuning process. For the first case, during tuning the plurality of GA parameters, the apparatus 1300 may utilize the interactive GUI 1301 to consolidate and aggregate the real-time tuning data 1303 from the auto-tuning process 1302 in order to visualize the auto-tuning process 1302 with the interactive GUI 1301. For the second case, during tuning the plurality of GA parameters, the apparatus 1400 may utilize the interactive GUI 1401 to consolidate and aggregate the real-time tuning data 1403 from the auto-tuning process 1402 in order to visualize the auto-tuning process 1402 with the interactive GUI 1401.

For better comprehension, the method may be illustrated with the working flow shown in FIG. 15, but the present invention is not limited thereto. According to some embodiments, one or more steps may be added, deleted, or changed in the working flow shown in FIG. 15.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling an auto-tuning process with aid of an interactive graphical user interface (GUI), the method comprising:
executing, by using a processing circuit within an electronic device, the auto-tuning process, for tuning a plurality of genetic-algorithm parameters (GA parameters) of a predetermined genetic algorithm; and
during tuning the plurality of GA parameters, utilizing the interactive GUI to consolidate and aggregate real-time tuning data from the auto-tuning process in order to visualize the auto-tuning process with the interactive GUI, wherein visualizing the auto-tuning process with the interactive GUI comprises generating at least one plot illustrating at least the real-time tuning data, for facilitating and accelerating interaction between a user and the auto-tuning process.

2. The method of claim 1, wherein the at least one plot is configurable to suit at least one specific requirement.

3. The method of claim 1, wherein the at least one plot is generated according to at least one configuration among multiple predetermined configurations.

4. The method of claim 1, wherein the at least one plot is generated according to a first configuration for providing multiple display options, wherein the multiple display options comprises a first display option for displaying the real-time tuning data using any plot among a two-dimensional (2D) plot and a three-dimensional (3D) plot, and a second display option for displaying the real-time tuning data using any plot among a colored plot and an uncolored plot.

5. The method of claim 1, wherein the at least one plot is generated according to a second configuration for providing multiple axis options, wherein the multiple axis options comprises a first axis option for defining a first axis as a first type of data, and a second axis option for defining a second axis as a second type of data.

6. The method of claim 1, wherein the at least one plot is generated according to a third configuration for providing multiple reference-line options, wherein the multiple reference-line options comprises a first reference-line option for displaying at least one baseline with any drawing object among multiple predetermined drawing objects, and a second reference-line option for displaying at least one auxiliary line corresponding to any data classification criterion among multiple predetermined data classification criteria.

7. The method of claim 1, wherein the at least one plot is generated according to a fourth configuration for providing multiple filter-out options, wherein the multiple filter-out options comprises a first filter-out option for filtering out a first portion of data that is not of interest according to a first user-setting range, and a second filter-out option for filtering out a second portion of data that is not of interest according to a second user-setting range.

8. The method of claim 1, wherein the at least one plot is generated according to a fifth configuration for providing multiple hyperparameter options, wherein the multiple hyperparameter options comprises a first hyperparameter option for displaying a first hyperparameter, and a second hyperparameter option for displaying a second hyperparameter.

9. The method of claim 1, wherein visualizing the auto-tuning process with the interactive GUI further comprises generating at least one interactive object for the user to enable interactive communication with the auto-tuning process.

10. The method of claim 9, wherein the at least one interactive object is arranged to input a user setting regarding at least one hyperparameter among multiple hyperparameters related to the predetermined genetic algorithm into the auto-tuning process.

11. The method of claim 1, wherein the interactive GUI is arranged to consolidate and aggregate the real-time tuning data from the auto-tuning process in order to visualize the auto-tuning process with the interactive GUI, for generating at least one visualization result of visualizing the auto-tuning process with the interactive GUI; and a first visualization result among the at least one visualization result comprises a single-objective tuning visualization, where the single-objective tuning visualization represents a visualization for single-objective tuning, and a single objective of the single-objective tuning comprises an objective of achieving an extreme value with respect to a single axis.

12. The method of claim 1, wherein the interactive GUI is arranged to consolidate and aggregate the real-time tuning data from the auto-tuning process in order to visualize the auto-tuning process with the interactive GUI, for generating at least one visualization result of visualizing the auto-tuning process with the interactive GUI; and a second visualization result among the at least one visualization result comprises a multi-objective tuning visualization, where the multi-objective tuning visualization represents a visualization for multi-objective tuning, and multiple objectives of the multi-objective tuning comprise a first objective of achieving a first extreme value with respect to a first axis and a second objective of achieving a second extreme value with respect to a second axis.

13. The method of claim 1, wherein the interactive GUI is arranged to consolidate and aggregate the real-time tuning data from the auto-tuning process in order to visualize the auto-tuning process with the interactive GUI, for generating at least one visualization result of visualizing the auto-tuning process with the interactive GUI; and a third visualization result among the at least one visualization result comprises a hyperparameters configuring visualization, where the hyperparameters configuring visualization represents a visualization for configuring of multiple hyperparameters, and the configuring of the multiple hyperparameters comprises one or a combination of a configuring history of the multiple hyperparameters and a configuring log of the multiple hyperparameters.

14. The method of claim 1, wherein the interactive GUI is arranged to consolidate and aggregate the real-time tuning data from the auto-tuning process in order to visualize the auto-tuning process with the interactive GUI, for generating at least one visualization result of visualizing the auto-tuning process with the interactive GUI; and a fourth visualization result among the at least one visualization result comprises a tuning-progress monitoring visualization, where the tuning-progress monitoring visualization represents a visualization for tuning-progress monitoring, and the visualization for the tuning-progress monitoring is implemented by using distinct progress indicators of multiple passes, for monitoring tuning progresses corresponding to the multiple passes, respectively.

15. The method of claim 1, wherein the interactive GUI is arranged to consolidate and aggregate the real-time tuning data from the auto-tuning process in order to visualize the auto-tuning process with the interactive GUI, for generating at least one visualization result of visualizing the auto-tuning process with the interactive GUI; and a fifth visualization result among the at least one visualization result comprises a pass-in-pipeline monitoring visualization, where the pass-in-pipeline monitoring visualization represents a visualization for pass-in-pipeline monitoring regarding multiple passes in a pipeline, and the visualization for the pass-in-pipeline monitoring is implemented by providing selectable objects corresponding to multiple passes in a pipeline for selecting any pass among all of the multiple passes in the pipeline.

16. The method of claim 1, wherein the interactive GUI is arranged to consolidate and aggregate the real-time tuning data from the auto-tuning process in order to visualize the auto-tuning process with the interactive GUI, for generating at least one visualization result of visualizing the auto-tuning process with the interactive GUI; and a sixth visualization result among the at least one visualization result comprises a individual-data pop-up visualization, where the individual-data pop-up visualization represents a visualization for illustrating any individual data among all individual data in a pop-up manner, and the visualization for illustrating the any individual data is implemented by illustrating the any individual data in detail in a table in response to an item corresponding to the any individual data in the individual-data pop-up visualization is selected by the user.

17. The method of claim 1, wherein the real-time tuning data comprises multiple calculation results collected from multiple calculation operations of the auto-tuning process during tuning the plurality of GA parameters; and utilizing the interactive GUI to consolidate and aggregate the real-time tuning data from the auto-tuning process in order to visualize the auto-tuning process with the interactive GUI further comprises:
collecting the multiple calculation results from the multiple calculation operations, for aggregating the real-time tuning data from the auto-tuning process; and
illustrating the multiple calculation results with the at least one plot, for consolidating the real-time tuning data from the auto-tuning process.

18. The method of claim 17, wherein collecting the multiple calculation results from the multiple calculation operations for aggregating the real-time tuning data from the auto-tuning process further comprises:
collecting the multiple calculation results from the multiple calculation operations while adjusting at least one GA parameter among the plurality of GA parameters, for aggregating the real-time tuning data from the auto-tuning process.

19. The method of claim 17, wherein illustrating the multiple calculation results with the at least one plot for consolidating the real-time tuning data from the auto-tuning process further comprises:
illustrating the multiple calculation results with the at least one plot in a standardized data structure to ensure consistency, for consolidating the real-time tuning data from the auto-tuning process.

20. An apparatus for controlling an auto-tuning process with aid of an interactive graphical user interface (GUI), the apparatus comprising:
a first processing circuit, arranged to control operations of the apparatus, wherein the interactive GUI is running on the first processing circuit;
wherein:
a second processing circuit within an electronic device is arranged to execute the auto-tuning process, for tuning a plurality of genetic-algorithm parameters (GA parameters) of a predetermined genetic algorithm; and
during tuning the plurality of GA parameters, the interactive GUI running on the first processing circuit is arranged to consolidate and aggregate real-time tuning data from the auto-tuning process in order to visualize the auto-tuning process with the interactive GUI, wherein visualizing the auto-tuning process with the interactive GUI comprises generating at least one plot illustrating at least the real-time tuning data, for facilitating and accelerating interaction between a user and the auto-tuning process.

21. The apparatus of claim 20, wherein the apparatus comprises the electronic device, wherein the second processing circuit is equal to the first processing circuit.

22. The apparatus of claim 20, wherein the apparatus comprises a first electronic device, wherein the electronic device represents a second electronic device that is coupled to the first electronic device via at least one network.
